(19) United States
(12) Patent Application Publication
(10) Pub. No.: US 2017/0283593 A1
(43) Pub. Date: Oct. 5, 2017

(54) ADDITIVES FOR RUBBER COMPOSITIONS

(71) Applicant: Arizona Chemical Company, LLC, Jacksonville, FL (US)

(72) Inventors: Neil Martin RIDDLE, Almere (NL); Godfried J.H. BUISMAN, Savnnah, GA (US); Yvette VERDONK, Diemen NLD (NL)

(73) Assignee: Arizona Chemical Company, LLC, Jacksonville, FL (US)

(21) Appl. No.: 15/518,466

(22) PCT Filed: Dec. 4, 2015
(86) PCT No.: PCT/US15/64019

§ 371 Date: Apr. 11, 2017

Related U.S. Application Data
(60) Provisional application No. 62/095,232, filed on Dec. 22, 2014.

(51) Int. Cl. C08K 11/00; C08K 5/548; C08J 3/20; C08K 3/36

(52) U.S. Cl. CPC C08K 11/00; C08K 3/36; C08K 5/548; C08J 3/203; C08J 2309/06; C08J 2409/00

(57) ABSTRACT

The instant invention relates to rubber compositions comprising silica, an organosilane having at least one cyclic and/or bridged alkoxy group and a rosin-containing material. The instant invention also relates to tires comprising such rubber compositions, to methods of preparation of such rubber compositions or tires thereof, and to the use of rosin-containing materials for improving the Mooney viscosity of rubbers comprising the same (e.g. in a tire).

### FIELD OF THE INVENTION

The instant invention relates to rubber compositions comprising silica, an organosilane containing hydroxy, cyclic and/or bridged alkoxy groups, and a rosin-containing material. The instant invention also relates to tires comprising such rubber compositions, to methods of preparation of such rubber compositions or tires thereof, and to the use of rosin-containing materials for improving the Mooney viscosity and mechanical properties of rubbers comprising the same (e.g. in a tire).

### BACKGROUND

Silanes have been used in rubber compositions as adhesion promoters, as cross-linking agents and as surface-modifying agents. Reference is made to, e.g, E. P. Plueddemann, “Silane Coupling Agents”, 2nd ed. Plenum Press 1982.

Several commonly used silanes include alkoxy silanes and organomercapto silanes, such as aminoalkyltrialkoxysilanes, methacryloxyalkyltrialkoxysilanes, polysulfanalkyltrialkoxysilanes, mercaptoalkyltrialkoxysilanes and mercaptothiocarboxylate oligomers. U.S. Pat. No. 7,683,115 describes the phenomena that occurs when using organomercapto silanes, which contain multiple mercapto and silanol functional groups, with diene based elastomers that the uncured viscosity of the resultant compound increases significantly. This poses significant problems in the processing of the compound. It is indicated in this patent that the use of a zinc oxide, stearic acid system with increased levels of stearic acid and a modified vulcanisation system would mitigate this problem.

Viscosity reduction of silica filled rubber compound by the use of fatty acid blend with zinc and without zinc has been presented by Struktol as: “Faster Processing of High Performance Silica Compounds”—Presented at Congresso Brasileiro de Tecnologia da Borracha 2012.

Examples of the use of rosin derivatives in rubber compositions include for instance those described in US 2009/0209690 and US 2009/069474.

US 2009/0209690 describes rubber compositions which contain a combination of silica reinforcement and plant-derived liquid partially decarboxylated rosin. This document describes that numerous coupling agents may be used for coupling silica, chiefly polysulfanes (e.g. containing polysulfide bridge), and generally mentions organomercaptoalkoxysilanes, without describing their structure. Actually this patent excludes the use of rosin with typical acid numbers around 160 mg KOH/g and claims the use of decarboxylated rosin oils with typical acid numbers between 2 and 30 mg KOH/g.

US 2009/069474 describes a tire with a tread of a rubber composition which contains zinc resinate within and on the surface of said rubber composition. A number of coupling agents are described to be used in conjunction with silica. Organo-alkoxymercaptosilanes are mentioned alongside polysulfanes such as bis-(3-trialkoxysilylalkyl)polysulfides.

The use of rosin-containing materials in combination with organosilanes having hydroxy, cyclic and/or bridged alkoxy groups and/or blocked and unblocked mercapto groups in silica-containing rubber compositions has not been described. Also, the benefits of the use of rosin-containing materials in combination with organosilanes as described herein, in particular with respect to improvements of Mooney viscosity of rubber compositions comprising the same, have neither been described nor suggested.

### SUMMARY

One embodiment of the present invention relates to a rubber composition including:

(A) a rubber;

(B) silica;

(C) an organosilane having hydroxy, cyclic and/or bridged alkoxy groups; and

(D) a rosin-containing material (comprising at least one rosin compound and derivatives thereof) selected from at least one of rosin, dimerized rosin, hydrogenated rosin, disproportionated rosin, decarboxylated rosin and rosin ester.

Another embodiment of the present invention relates to the use of a rosin-containing material selected from rosin, dimerized rosin, hydrogenated rosin, disproportionated rosin, decarboxylated rosin and rosin ester (component D) in a rubber composition further including:

a rubber (component A);

silica (component B); and

an organosilane having hydroxy, cyclic and/or bridged alkoxy groups;

to obtain a rubber composition having, when the rubber composition is not cured, a reduced Mooney viscosity and equivalent mechanical properties when compared to a similar uncured rubber composition without component D.

A further embodiment of the present invention relates to a method for preparing a rubber composition including mixing:

(A) a rubber;

(B) silica;

(C) an organosilane having hydroxy, cyclic and/or bridged alkoxy groups; and

(D) a rosin-containing material selected from rosin, dimerized rosin, hydrogenated rosin, disproportionated rosin, decarboxylated rosin and rosin ester.

### DETAILED DESCRIPTION

It has now been found that the use of rosin-containing materials in combination with organosilanes and silica leads to rubber compositions with improved properties.

In particular, rosin-containing materials have been found to improve the Mooney viscosity of rubber compositions comprising silica and such organosilanes.

Accordingly, rubber compositions as described herein advantageously improve the manufacture and the properties of said rubber compositions and of products comprising the same.

Organosilanes as described herein are distinct from other organosilanes, and in particular from commonly used alkoxy substituted organosilanes, in the groups that are bound to the silicon atom. In one embodiment, the organosilanes as described herein may have at least one mercapto and silanol functional group.

In several embodiments, organosilanes as described herein have at least one mercapto group chemically blocked group. Herein, organosilanes with such blocked groups will be referred to as blocked organosilanes.

The term “organosilanes” as used herein shall mean a non-polymeric, dimeric or oligomeric silane having at least one hydroxy, cyclic or bridged alkoxy group, optionally with at least one mercapto and/or silanol functional group and minimal ethoxy groups.

In several embodiments, organosilanes as described herein have at least one blocked group and at least one unblocked group.

Such groups confer different properties to organosilanes and to rubber compositions comprising the same than other commonly used organosilanes. For instance, organosilanes having blocked mercapto, have different kinetic behaviour when compared to organosilanes having unblocked mercapto groups.

Without being bound to any theory, the blocked groups are expected to play an important role in the reaction mechanism between the silane and the silanol group of the silica. Reference is made, e.g., to the publication “Kinetics of the SilicaSilane Reaction” in Kautschuk Gummi Kunststoffe (KGK) of April 2011 (pp. 38-43) by A. Blume and to the publication “Reactive Processing of Silica-Reinforced Tire Rubber—New insight into the time and Temperaure Dependance of Silica Rubber Interaction” by Satoshi Mihara 2009.

Accordingly, in several aspects the instant invention relates to a rubber composition comprising a rubber, silica, an organosilane, and a rosin-containing material. In one embodiment, the organosilanes may include diol derived organosilanes which contain multiple mercapto and silanol functional groups. In another embodiment, the silanes contain hydroxy, cyclic and/or bridged alkoxy groups derived from hydrocarbon based diols and/or a minimal content of ethoxy groups.

A rosin-containing material is a composition which comprises a rosin compound, and generally comprises a mixture of rosin compounds. Herein a rosin compound means a rosin acid or a compound derived from a rosin acid. A compound derived from a rosin acid is a compound obtained by subjecting a material comprising a rosin acid to, e.g., at least one of a dimerization reaction, a hydrogenation reaction, disproportionation reaction, a decarboxylation reaction and an esterification reaction.

A rosin-containing material in rubber compositions as described herein is selected from rosin, dimerized rosin, hydrogenated rosin, disproportionated rosin, decarboxylated rosin and rosin ester. In several embodiments the rosin-containing material is selected from rosin, dimerized rosin, hydrogenated rosin, and disproportionated rosin. In several embodiments, the rosin-containing material is a rosin, in particular is a rosin selected from tall oil rosin, gum rosin, wood rosin, and more in particular may be tall oil rosin.

Rosin is a resinous material that is obtained from many plants, particularly coniferous trees such as Pinus Sylvestris, Pinus palustris and Pinus caribaea. Rosin comprises a mixture of rosin acids, which generally include C₂₀ fused-ring monocarboxylic acids, with a nucleus of three fused six-carbon rings and double bonds that vary in number and location, and other components in minor quantities. Examples of rosin acids include abietic acid, neoabietic acid, dehydroabietic acid, pimaric acid, levopimaric acid, sandaracopimaric acid, isopimaric acid and palustric acid. The type and relative amounts of rosin acids present in rosin depend, in part, on the plant species and the process of production.

Rosin can be obtained from pine trees by distillation of oleoresin (the residue of said distillation is known as “gum rosin”), by extraction of pine stumps (known as “wood rosin”) or by fractionation of tall oil (known as “tall oil rosin”). Tall oil rosin may be particularly used. Other rosin-containing materials obtained during the production of tall oil rosin such as distilled tall oil (DTO), tall oil fatty acid (TOFA) and crude tall oil (CTO) may also be used. All of these sources of rosin are examples of rosin-containing materials suitable for use in the compositions and methods described herein which are known in the art and are commercially available. Sources of rosin may contain major components other than rosin acids. In particular DTO, CTO and TOFA are mixtures of fatty acids and rosin acids, i.e. comprising fatty acids as major components in addition to rosin acids. The composition of DTO and CTO is described in more detail below.

Each of the terms “dimerized rosin”, “hydrogenated rosin”, “disproportionated rosin” and “decarboxylated rosin” refers to rosin (i.e. a mixture of rosin acids as defined above), which has been subjected to a dimerization reaction, a hydrogenation reaction, disproportionation and a decarboxylation reaction respectively. The production of these types of rosin-containing material is known in the art.

The term “rosin ester” refers to an ester of rosin (i.e. a mixture of rosin acids as defined above) and at least one alcohol.

Suitable alcohols for esterification include monoalcohols, such as methanol, ethanol, butanol, C8-11 isoalcohols (such as isodecylalcohol and 2-ethylhexanol), and polyols such as diethylene glycol, triethylene glycol, glycerol, pentaerythritol, sorbitol, neopentyl glycol and trimethylolpropane. In particular, useful alcohols include diethylene glycol, triethylene glycol and pentaerythritol. Rosin esters may be obtained from rosin and alcohols by methods known in the art. For example, reference is made to the processes described in the patent document U.S. Pat. No. 5,504,152, which is incorporated herein by reference. In general, rosins may be esterified by a thermal reaction of rosin acids contained therein with an alcohol (i.e. one or more alcohols). In order to drive such esterification reactions to completion water may be removed from the reactor, by, for instance, distillation, application of vacuum, and other methods known to the skilled person.

The rosin-containing material may generally comprise from 1 wt. % to 99.99 wt. % of rosin compounds. The remaining of the rosin-containing material to 100 wt. % consists of components other than rosin compounds, including, for instance, fatty acids (e.g. stearic acid, oleic acid, linoleic acid, linolenic acid and pinolenic acid); high molecular weight alcohols (e.g. fatty alcohols and sterols); alkyl hydrocarbon derivates; residual terpene monomers such as α-pinene, β-pinene and other mono and bicyclic terpenes; other unsaponifiables; and trace metals.

The exact composition of rosin-containing materials may vary. For instance, the composition of wood rosin, gum rosin, tall oil rosin (TOR) distilled tall oil (DTO) and crude tall oil (CTO), may vary depending on the starting materials and processing steps used in their production. These will also influence the composition of rosin-containing materials derived therefrom (e.g. dimerized rosin, hydrogenated rosin, disproportionated rosin, decarboxylated rosin and rosin ester).

A wood rosin may particularly comprise 75-99 wt. % (in particular 85-98 wt. %) of rosin acids, 2-5 wt. % of fatty acids, 2-10 wt. % of monoterpenes and diterpenes, and other components to a total of 100 wt. %, including, e.g., any of the additional components described above to be present in rosin, in particular, 4-8 wt. % of other acids and unsaponifiables.

A gum rosin may particularly comprise 75-99 wt. % (in particular 85-98 wt. %) of rosin acids, 2-5 wt. % of fatty acids, 2-10 wt. % of monoterpenes and diterpenes, and other components to a total of 100 wt. %, including, e.g., any of the additional components as described above and, in particular, other acids and unsaponifiables.

A tall oil rosin may particularly comprise 75-99 wt. % (in particular 80-95 wt. %) of rosin acids, 2-10 wt. % of fatty acids, and other components to a total of 100 wt. %, including, e.g., any of the additional components as described above and, in particular, other acids and unsaponifiables.

A distilled tall oil may particularly comprise 10-40 wt. % of rosin acids, from 50 to 80 wt. % of fatty acids and other components to a total of 100 wt. % including, e.g., any of the additional components as described above and, in particular, unsaponifiables.

A crude tall oil may particularly comprise from 10 to 50 wt. % of rosin acids, from 40 to 70 wt. % of fatty acids, and other components to a total of 100 wt. %, including, e.g., any of the additional components as described above and, in particular, high molecular weight alcohols, sterols and unsaponifiables.

Rosin-containing materials as described herein may generally have an acid number from 0.5 to 190 mg KOH/g, in particular from 1 to 185 mg KOH/g, more in particular from 1.5 to 180 mg KOH/g, yet more in particular from 2 to 175 KOH/g. The acid number can be determined according to ASTM D465 using a standard titration with sodium hydroxide solution.

Rosin-containing materials as described herein may be viscous liquids or may be solids at room temperature. Viscous liquids may generally have Brookfield viscosities of at most 1500 cps, in particular of at most 1000 cps, and more in particular of at most 500 cps at 50° C., as measured by methods known in the art. Rosin-containing materials solid at room temperature may generally have a softening point from 40 to 170° C., in particular from 45 to 160° C., more in particular from 50 to 150° C., yet more in particular from 55 to 145° C. The softening point can be measured by the Ring and Ball method (ASTM E28-97), whereby a sample of the rosin-containing material is poured molten into a metal ring, and is subsequently cooled. The ring is cleaned in such a way that the rosin-containing material fills the ring, a steel ball is placed resting on top of the resin. The ring and ball are placed in a bracket which is lowered into a beaker containing a liquid (e.g. water, glycerol or silicone oil depending on the expected softening point), and the solvent is heated at 5° C. per minute while being stirred. When the ball drops completely through the ring, the temperature of the solvent is recorded as the Ring & Ball softening point.

The properties of rosin-containing materials may vary, and may depend on the specific type of rosin-containing material. For instance, rosins, dimerized rosins, hydrogenated rosins, disproportionated rosins, decarboxylated rosins and rosin esters, will generally have the properties described above for rosin-containing materials, in particular with respect to the amount of rosin compounds, acid number and softening points. However, specific compositions and properties may be obtained depending on the starting source of rosin, and specific preparation and reaction conditions.

Rosins may have an acid number from 125 to 190 mg KOH/g, in particular from 140 to 180 mg KOH/g, more in particular from 150 to 175 mg KOH/g and have a softening points from 40 to 100° C., in particular from 50 to 90° C., and more in particular from 60 to 75° C.

Dimerized rosins may particularly have an acid number from 120 to 190 mg KOH/g, in particular from 130 to 180 mg KOH/g, more in particular from 135 to 175 mg KOH/g and a softening point from 60 to 160° C., and in particular from 80 to 140° C.

Hydrogenated rosins may have an acid number from 140 to 180 mg/g KOH and a softening point from 40 to 80° C.

Disproportionated rosins may have an acid number from 130 to 180 mg KOH/g, in particular from 140 to 165 mg KOH/g, and a softening point from 40 to 90° C. and more in particular from 45 to 85° C.

Decarboxylated rosins may have an acid number from 10 to 175 mg KOH/g, in particular from 25 to 125 mg KOH/g, more in particular from 35 to 100 mg KOH/g. Generally, decarboxylated rosins are viscous liquids at room temperature and may particularly have a Brookfield viscosity of at most 1000 cps at 50° C., as measured by methods known in the art.

Rosin esters may have an acid number from 0.50 to 100 mg KOH/g, in particular from 1.0 to 80 mg KOH/g, more in particular from 1.5 to 75 mg KOH/g and a softening point from 80 to 130° C., in particular from 85 to 125° C. The softening point may vary depending on the polyalcohols used in the preparation of rosin esters and on whether rosin esters are further modified, by, e.g., dimerization and/or fortification with for example maleic anhydride or fumaric acid has been applied. Reference is made to, e.g., Naval Stores, F. Zinkel and J. Russel 1989, Chapter 9, pp 282-285.

Rosin-containing materials are generally present in rubber compositions as described herein in amounts from 0.001-75 parts per hundred parts of rubber (phr), in particular from 0.01 to 50 phr, more in particular from 0.1 to 25 phr, more in particular from 0.25 to 10 phr, and yet more in particular from 0.5 to 5.0 phr.

The term “parts per hundred parts of rubber” or “phr” is commonly used in the art of rubber compositions and refers to weight parts of a component present in a rubber composition per 100 parts by weight of rubber. The weight parts of rubber present in the composition is calculated on the total amount of rubber used as component (A). Hence, if more than one rubber is used, e.g. if a mixture of rubbers is used, the phr is calculated on the basis of the total weight amount of the rubber mixture.

The amount of rosin-containing material present in rubber compositions as described herein may be based on the amount of organosilane also present therein. In particular, the amount of rosin-containing material may be from 1 to 100 wt. % based on the total weight amount of organosilane, in particular from 2.5 to 75 wt. %, more in particular from 5 to 50 wt. %, even more in particular from 10 to 30 wt. %, yet more in particular from 15 to 25 wt. %.

A rubber composition as described herein may comprise any type of rubber selected from natural and synthetic rubbers, including solution polymerizable or emulsion polymerizable elastomers.

Suitable rubbers include polymers of at least one monomer selected from olefin monomers, including: monoolefins such as ethylene, propylene; conjugated diolefins such as isoprene and butadiene; triolefins; and aromatic vinyl's such as styrene and alpha methyl styrene.

Natural rubber is also known as India rubber or caoutchouc and comprises polymers of isoprene as its main component. Natural rubber is generally obtained from trees from the species Hevea Brasiliensis, from Guayule dandelion and Russian Dandelion.

Suitable synthetic rubbers are described, for example, in the book Kautschuktechnologie by W. Hofmann, published by Gentner Verlag, Stuttgart, 1980.

Solution and emulsion polymerization elastomers are well known to those of ordinary skill in the art. For example, conjugated diene monomers, monovinyl aromatic monomers, triene monomers, and the like, can be anionically polymerized to form, e.g., polymers, copolymers and terpolymers thereof.

In particular, suitable rubbers may be selected from at least one of natural rubber (NR), polybutadiene (BR), polyisoprene (IR), styrene/butadiene copolymers (SBR), styrene/isoprene copolymers (SIR), isobutylene/isoprene copolymers (IIR also known as butyl rubber), ethylene acrylic rubber, ethylene vinyl acetate copolymers (EVA), acrylonitrile/butadiene copolymers (NBR), partly hydrogenated or completely hydrogenated NBR rubber (HNBR), ethylene/propylene rubber, ethylene/propylene/diene terpolymers (EPDM), styrene/isoprene/butadiene terpolymers (SIBR), chloroprene (CR), chlorinated polyethylene rubber, fluoroelastomers chlorosulfonated polyethylene rubbers, tetrafluoroethylene/propylene rubber, epichlorohydrin rubbers and silicone rubber.

Further, suitable rubbers include the above mentioned rubbers which additionally have functional groups, such as carboxyl groups, silanol groups, siloxy groups epoxide groups and amine groups. The functionalization of rubbers is well known in the art. Examples of functionalized rubbers include, for instance, epoxidized natural rubber, carboxy-functionalized NBR, silanol-functionalized (—SiOH)SBR or siloxy-functionalized (—Si—OR)SBR) amine functionalized SBR. Such functional rubbers may react with the silica and silanes present in the rubber composition. However, non-functionalized rubbers may be particularly used.

In particular, rubbers may be selected from at least one of styrene/butadiene copolymer (SBR), polybutadiene (BR), natural rubber, polyisoprene, isobutylene copolymer (IIR), styrene/isoprene/butadiene terpolymer (SIBR), and isoprene/styrene copolymer; even more in particular from at least one of styrene/butadiene copolymer (SBR) polybutadiene (BR) and natural rubber.

A composition as described herein may comprise a mixture of two or more rubbers described above. In particular, component (A) of a composition as described herein may be a mixture of any one of styrene/butadiene copolymer (SBR), polybutadiene (BR), natural rubber, polyisoprene, isobutylene copolymer (IIR), styrene/isoprene/butadiene terpolymer (SIBR), isoprene/styrene copolymer and functionalized rubber. More in particular a rubber mixture may comprise at least two of styrene butadiene copolymer (SBR), polybutadiene (BR) and natural rubber.

Polybutadienes (BR) may be selected from high cis 1,4-polybutadiene and high vinyl polybutadiene. A high vinyl polybutadiene generally has a vinyl content from 30 to 99.9 wt. %, wherein the weight percentage (wt. %) is based on the total weight amount of polybutadiene. A high cis 1,4-polybutadiene may generally have a cis 1,4-butadiene content of 90-99.9 wt. % on the total weight amount of polybutadiene. In several embodiments, a polybutadiene may be a high cis 1,4-polybutadiene with 99.5 wt. % of cis 1,4-butadiene monomer.

Polyisoprenes (IR) may be cis 1,4-polyisoprene (natural and synthetic).

Styrene butadiene copolymers (SBR) may be derived from an aqueous emulsion polymerization (E-SBR) or from an organic solution polymerisation (S-SBR), solution polymerized SBR may be particularly used. An example of a commercially available solution-polymerized SBR (oil extended) is Duradene™ from Firestone Polymer. A SBR (either E-SBR or S-SBR) may have styrene contents of from 1 to 60 wt. %, particularly from 5 to 50 wt. %, wherein the weight percentage (wt. %) is based on the total weight amount of SBR.

Acrylonitrile/butadiene copolymers (NBR) may have acrylonitrile contents of from 5 to 60, preferably 10 to 50 wt. %, wherein the weight percentage (wt. %) is based on the total weight amount of NBR.

Rubber compositions as described herein comprise silica, which acts as reinforcing filler.

Silica may be selected from at least one of amorphous silica (such as precipitated silica), wet silica (i.e. hydrated silicic acid), dry silica (i.e. anhydrous silicic acid) and fumed silica (also known as pyrogenic silica). The silica can also be in the form of mixed oxides with other metal oxides, such as aluminum oxide, magnesium oxide, calcium oxide, barium oxide, zinc oxide and titanium oxide.

In several embodiments, silica may be amorphous silica, precipitated silica.

Examples of suitable commercially available silicas include, but are not limited to, Hi-Sil™ (R) 190, Hi-Sil™ (R) 210, Hi-Sil™ (R) 215, Hi-Sil™ (R) 233, Hi-Sil™ (R) 243, and the like, from PPG Industries (Pittsburgh, Pa.); Ultrasil™ VN2, VN3, VN2 GR, VN3 GR, and highly dispersible silica Ultrasil™ 7000 GR, 9000GR from Evonik; Zeosil™ 1085 GR, highly dispersible silica Zeosil™ 1115 MP, 1115, 115GR, 1165 MP, and Zeosil™ Premium 200 from Solvay; and Zeopol™ 8745 and 8755 LS from Huber.

A silica may generally have a specific surface area (BET surface area) from 5 to 1000 m²/g, in particular from 10 to 750 m²/g, more in particular from 25 to 500 m²/g, even more in particular from 50 to 250 m²/g, and may generally have a particle size from 10 to 500 nm, in particular from 50 to 250 nm, more in particular from 75 to 150 nm. Methods of measuring silica surface area and particle size are well known in the art. In particular, the silica surface area may be measured by the commonly used BET method.

The pH of silica may generally be of about 5.5 to about 7 or slightly over, preferably about 5.5 to about 6.8.

A rubber composition as described herein may generally comprise silica in an amount from 5 to 150 phr, in particular from 25 to 130 phr, more in particular from 40 to 115 phr.

A rubber composition as described herein may comprise additional fillers other than silica, such as carbon black; metal hydroxides (e.g. aluminum hydroxide); silicates such as aluminum silicate, alkaline earth metal silicates (including magnesium silicate or calcium silicate), including mineral silicates such as clay (hydrous aluminum silicate), talc (hydrous magnesium silicate), mica and bentonite; carbonates (e.g. calcium carbonate); sulfates (e.g. calcium sulfate or sodium sulfate); metal oxides (e.g. titanium dioxide) and mixtures thereof.

In particular, a rubber composition as described herein may comprise both silica and carbon black or both silica and aluminum hydroxide as the filler.

When present, said additional fillers may be present in rubber compositions in amounts from 0.5 to 40 phr, in particular from 1 to 20 phr and, more in particular from 2.5 to about 10 phr. The amount of additional fillers may be chosen based on the amount of silica present in the rubber compositions as described above. The additional filler may be present in a weight ratio (additional filler to silica) from 70:30 to 1:99, more in particular from 50:50 to 10:90, more in particular from 40:60 to 20:80.

Rubber compositions as described herein comprise an organosilane having at least one hydroxyl, cyclic and/or bridged alkoxy group, and optionally, at least one blocked mercapto group and/or at least one unblocked mercapto group. In another embodiment, organosilanes as described herein have at least one blocked mercapto group, at least one blocked group and at least one unblocked group. In another embodiment, organosilanes as described herein have at least one blocked mercapto group and at least one unblocked mercapto group and at least one hydroxy, cyclic and/or bridged alkoxy group.

In another embodiment, the organosilane may be the product of reacting a hydrocarbon-based diol (e.g., 3-methyl-1,3-propane diol) with S-[3-(triethoxysilyl)propyl] thiooctanaote as refered to in U.S. Pat. No. 8,609,877 which is incorporated herin in its entirety. It is considered herein that alternately, said organosilane may be a product of said diol and S-[3-(trichlorosilyl)propyl] thiooctanaote.

In another aspect, it is envisioned herein that such organosilane may be comprised of, for example, a generalised illustrative structure (I):

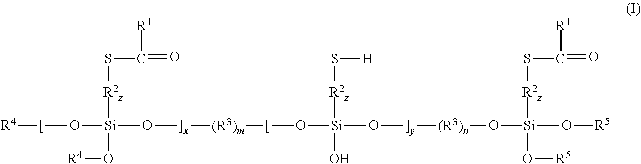

Wherein R¹ is a hydrocarbon radical containing from 4 to 10 carbons, preferably an alkyl radical and preferably containing 7 carbon atoms;

Wherein R² is an alkylene radical containing from 3 to 6 carbon atoms, preferably 4 carbon atoms;

Wherein R³ is an alkylene radical containing from 3 to 8 carbon carbon atoms, preferably 4 carbon atoms;

Wherein the R⁴ radicals are the same or different alkyl radicals containing from 3 to 8 carbon atoms;

Wherein the R⁵ radicals are:
(A) The same or different alkyl radicals containing from 3 to 8 carbon atoms, or
(B) Combined to form an individual alkyl radical, which may be a branched or unbranched alkyl radical, having from 3 to 8 carbon atoms.

Wherein z is a value in the range of from 0 to 6,
Wherein the total of x and y is at least 1, which may be, for example of from 3 to about 15 or more; and
Wherein m and n are each values in a range of from 0 to 8.

It is contemplated that the various alcohol groups are reactive with hydroxyl groups (e.g., silanol groups) contained on the precipated silica and further, because they contain more than 2 carbon atoms) do not liberate ethanol (as a by-product) upon reacting with said hydroxyl groups on said precipated silica.

Oligomeric organosilanes described herein are discussed in “NXT Z Silane Processing and Properties of a New Virtally Zero VOC Silane” by D. Gurovich, et al., presented at the Fall 170^{th} Technical Meeting of the Rubber Division, American Chemical Society, on Oct. 10-12, 2006 at Cincinnati, Ohio, which presentation is incorporated herein in its entirety.

Oligomeric organosilanes described herein are discussed in “GE's New Ethanol Free Silane for Silica Tires” report by Antonio Chaves, et al., presented at an ITEC year 2006 Conference on Set. 12-14, 2006 as ITEC 2006 Paper 28B at Akron, Ohio, which refers to NXT Z™, which presentation is incorporated herein in its entirety.

Oligomeric organosilanes described herein are set forth in U.S. Pat. Nos. 8,008,519; 8,158,812; 8,609,877; 7,718,819; and 7,560,583, the entire subject matter of which is incorporated herein by reference.

Organosilanes as described herein are generally present in the rubber compositions in amounts from 0.05 to 75 phr, in particular from 0.1 to 60 phr, more in particular from 0.5 to 50 phr, even more in particular from 1 to 30 phr, and yet more in particular from 5 to 15 phr.

The amount of organosilane may be based on the amount of silica present in the rubber compositions as described herein. For instance, the amount of organosilane may be from 1 to 50 wt. % based on the total weight amount of silica present in the rubber composition, in particular from 5 to 30 wt. %, more in particular from 10 to 20 wt. %.

In several aspects, the instant invention relates to rubber compositions comprising

(A) a rubber;

(B) 5-150 phr of silica;

(C) 0.05-75 phr of an organosilane; and

(D) 0.001-75 phr of a rosin-containing material;

wherein phr is the weight parts of each component (B), (C) or (D) per 100 weight parts of rubber component (A).

The amounts of each of the components may be varied as indicated above when describing each of the different components, in particular rubber compositions may comprise any combination of the specific amounts mentioned above for each component.

A rubber composition as described herein may comprise additional ingredients other than rubber (A), silica (B), oganosilane (C) and rosin-containing material (D).

The amount and type of additional components, if any, may depend on the final application of the rubber composition. Suitable additional components and amounts can be determined by a person skilled in the relevant art. Examples of additional components include, for instance, curing agents like 2,5-dimethyl-2,5-di(tert-butylperoxy)hexane (DTBPH) or dicumyl peroxide (DCP); curing or vulcanizing agents (e.g., sulphur, Vulkacit CS 1.5, Vulkacit D from Lanxess, and Rhenogran IS 60-75 from Rheinchemie); activators with maleimide groups like triallylcyanurate (TAC); peroxide retardants like derivatives from 4-tert-butylcatechol (TBC), methyl substituted amino alkylphenols and hydroperoxides; accelerators (e.g., 2-mercaptobenzothiazole (MBT), N-cyclohexyl-2-benzothiazylsulphenamide (CBS) or TMTD and sulphur); dispersing and processing aids like oils (e.g. TDAE, Vivatec™ 500 purchased from Hansen & Rosenthal); resins, plasticizers and pigments; fillers other than silica (such as those described above, e.g., Carbon Black); fatty acids (e.g., stearic acid); zinc oxide; waxes (e.g., Antilux™ 654 from Rheinchemie); antioxidants (e.g., IPPD, Vulkanox™ 4010 and 4020 from Lanxess); antiozonants (e.g., Durazone® 37 from SpecialChem); peptizing agents (e.g., diphenylguanidine, SDGP, Vulkacit™ IS6075 from Rheinchemie).

Several aspects of the instant invention also relate to methods of preparation of rubber compositions as described herein.

A method for preparing a rubber composition as described herein may comprise mixing:

(A) rubber;

(B) silica;

(C) organosilane having having at least one hydroxyl, cyclic and/or bridged alkoxy group; and

(D) rosin-containing material selected from rosin, dimerized rosin, hydrogenated rosin, disproportionated rosin, decarboxylated rosin and rosin ester.

Rubber compositions as described herein may be compounded or blended by using mixing equipments and procedures conventionally employed in the art.

The different components (A) to (D) and any other additional components may be mixed in any order.

What has been described above for the rubber composition, regarding the individual amounts of the different components and particular examples of each of the components, also applies to the method of preparation as described herein.

In several embodiments, an initial master batch may be prepared including part or all, generally all, of the rubber component (A) and an additional component selected from all or part of the silica component (B), and all or part of the organosilane component (C), all or part of the rosin-containing material component (D), and as well as other optional non-curing additives, such as processing oil, antioxidants and other additives commonly used in the art.

After the master batch is prepared, one or more optional remill stages can follow in which either no ingredients are added to the first mixture, or part of all of the remaining of silica component, organosilane component, rosin-containing material component, as well as other non-curing additives are added to the first mixture.

The master batch and any of the products obtained in the subsequent remill steps are commonly referred to as non-productive rubber compositions. Non-productive rubber lacks any curing agents (also referred to in the art as vulcanizing agents), and therefore no cross-linking will occur.

The next step may be the addition of curing agents to the mixture, to provide what is commonly known in the art as a productive rubber composition. This productive rubber composition will lead to a cross-linked rubber composition when subjected to curing (or vulcanizing) conditions. Herein, the cross-linked rubber composition will be referred to as cured rubber composition, which in the art is also known as vulcanized rubber composition. Accordingly, the method of preparation as described herein may further comprise curing said productive rubber compositions to provide a cured rubber composition.

A rubber may be pre-treated prior to being mixed with other components of the composition as described herein. For instance, a rubber used may be an oil extended rubber, i.e. rubber which has been treated with extender oil, or a solution master batch rubber in which the silica is pre-dispersed in the rubber. Such pre-treated rubbers are described in the literature and generally are commercially available. For instance, U.S. Pat. No. 7,312,271 describes the preparation of a solution masterbach rubber containing a diene elastomer in an organic solvent and a reinforcing silica filler dispersed therein. The article “Silica wet masterbatch” by Lightsey et. al. in the June volume of Rubber World 1998, describes a process that achieves essentially complete incorporation of silica during coagulation of traditional SBR or other latex. Suitable pre-treated rubbers include commercially available rubbers such as rubbers for shoe soles and for tire tread compounds for tires for trucks and passenger cars.

Silica may also be pre-treated prior to being mixed to other components of the rubber composition as described herein. Silica may be pre-treated with organosilane as described herein or may be pre-treated with a sulfur containing coupling agent other than organosilanes as described herein. Alternatively or additionally a silica may be pre-treated with other components commonly used in the art. Pre-treated silica is commercially available and/or may be prepared by known methods. For instance, U.S. Pat. No. 5,985,953, describes a compatibilized silica formed by the reaction of precipitated or fumed silica with organosilicon coupling compounds in aqueous suspension. U.S. Pat. No. 8,288,474 describes mercaptoalkylsilanes bound to silica and blocked mercaptoalkylsilanes bound to silica. Reference is also made to the publication “PPG's Agilon silicas ‘eliminate silanisation and outgassing” in the European Rubber Journal Vol. 191, No. 2: March/April 2009, page 12. Particular examples of commercially available pre-treated silicas include Ciptane™ 255 LD, which is a mercaptosilane fixed to silica with virtually no trialkoxysilane present, Agilon™ 400 and Hi-Sil™ from Pittsburgh Paint and Glass (PPG) Industries.

When silica pre-treated with an organosilane as described herein is used, all or part of the organosilane of the rubber composition as described herein may be added to the rubber composition in the form of said pre-treated silica.

It has been found that rubber compositions as described herein have advantages both as uncured rubber compositions (non-productive and productive) and as cured rubber compositions.

Accordingly, in several embodiments the rubber compositions as described herein may be uncured rubber compositions or cured rubber compositions. In several particular embodiments uncured rubber compositions may be non-productive or productive uncured rubber compositions.

Advantageously, rubber compositions as described herein improve the manufacture and the properties of products comprising the same.

In particular, rosin-containing materials as described herein may be used to provide uncured rubber (non-productive and/or productive) with reduced Mooney viscosity and equivalent mechanical properties, when compared to similar uncured rubber compositions without rosin-containing materials as described herein. The term ‘similar composition’ means a comparison composition which is the same as the composition of the invention in all its components and as regards to the selection of materials and amounts thereof with the exception that the similar composition does not contain any of the rosin-containing material (i.e. component D) which is part in the composition of the invention.

Rubber compositions as described herein, in particular uncured rubber, may display a Mooney viscosity which is from 1 to 65% lower, in particular from 2 to 60% lower, more in particular from 3 to 50% lower, even more in particular from 4 to 40% lower than the Mooney viscosity obtained for a similar composition without rosin-containing materials. The Mooney viscosity may be determined according to procedures described in ASTM-D 1646-8911 (ISO 289). For uncured rubber the Mooney viscosity may be measured at 100° C.

Rosin-containing materials as described herein may also be used to provide rubber compositions, cured or uncured, in particular uncured, more in particular uncured productive rubber compositions (also known as green rubber), with tensile mechanical properties which are at least as good, when compared to similar rubber compositions without rosin-containing materials as described herein. The tensile mechanical properties of the rubber can be measured using standard procedures such as those described in ASTM 6746-10 for uncured rubber and ISO 37 for cured rubber. Parameters commonly used in the art which may be measured include the tensile strengths measured at 50% elongation (M50), at 200% elongation (M200) and at 300% elongation (M300); the tensile strength at break (TB); and the elongation at break (EB). The M300/M100 ratio gives an idea of the reinforcement properties of the rubber composition.

Rosin containing rubber compositions as described herein give similar tensile strength and elongation at break results as rubber compositions without rosin-containing materials as described herein.

Rosin containing rubber compositions as described herein also provide rubber compounds where the vulcanisation properties are unaffected when compared to similar rubber compositions without rosin-containing materials as herein described. The cure properties of the rubber can be measured using standard procedures such as those described in ISO 6502. Parameters commonly used in the art which may be measured include the minimum force or torque, ML, the maximum force or torque, MH and time to a percentage full cure, e.g., 90% (TC90). Rosin containing rubber compositions as described herein give similar vulcanisation properties as rubber compositions without rosin-containing materials as described herein.

Rosin containing rubber compositions as described herein also provide rubber compounds where the rebound resilience properties are unaffected when compared to similar rubber compositions without rosin-containing materials as herein described. The cured resilience properties of the rubber can be measured using standard procedures such as those described in ISO 4662. Parameters commonly used in the art which may be measured include the rebound resilience as a percentage at different temperatures, e.g., 23° C. and 60° C. Rosin containing rubber compositions as described herein give similar vulcanisation properties as rubber compositions without rosin-containing materials as described herein.

Rosin containing rubber compositions as described herein also provide rubber compounds where the cured hardness properties are unaffected when compared to similar rubber compositions without rosin-containing materials as herein described. The cured hardness properties of the rubber can be measured using standard procedures such as those described in ISO 7619-1 using the Shore A method. Rosin containing rubber compositions as described herein give similar hardness properties as rubber compositions without rosin-containing materials as described herein.

Several aspects of the instant invention relate to the use of a rosin-containing material selected from rosin, dimerized rosin, hydrogenated rosin, disproportionated rosin, decarboxylated rosin and rosin ester (component D) in a rubber composition further comprising rubber (component A); silica (component B); and organosilane having cyclic and/or bridged alkoxy groups (component C) to obtain a rubber composition having, when the rubber composition is not cured, a reduced Mooney viscosity when compared to a similar uncured rubber composition without component D; and/or to obtain a rubber composition having, when the rubber composition is cured, suitable rolling resistance when compared to a similar cured rubber composition without component D.

The methods of preparation as described herein may result in rubber compositions having the any of the properties described above for the rubber composition. What has been described above for the rubber composition, in particular regarding:
the individual amounts of the different components;
particular examples of each of the components; and
regarding the Mooney viscosity, mechanical properties (such as the M300/M100 ratio, the elongation at break and tensile strength at break), also applies to the rubber of the uses, methods of preparation and applications as described herein.

Rubber compositions as described herein may be used in numerous applications, such as tires and industrial rubber goods (e.g. conveyor belts and shoe soles).

In particular, rubber compositions as described herein, can be advantageously used in tires, and more in particular, in tire treads. Accordingly, in several aspects, the instant invention relates to a tire comprising a rubber composition as described herein and to a tire comprising a rubber composition as described herein in the tread of the tire.

A tire comprising rubber compositions as described herein may generally comprise other components in addition to rubber (A), silica (B), organosilane (C) and rosin-containing material (D). Examples of additional components include any of the additional components that may be present in the rubber composition as described above.

Other aspects of the invention also relate to a method for maintaining the mechanical properties of cured rubber compositions, in particular maintaining the mechanical properties of a tire while improving the processing conditions, such as the viscosity, wherein the tire comprises a rubber composition as described herein.

In particular, the instant invention relates to the use of a rosin-containing material selected from rosin, dimerized rosin, hydrogenated rosin, disproportionated rosin, decarboxylated rosin and rosin ester (component D) to obtain a rubber composition having, when the rubber composition is cured, desirable mechanical properties (e.g., tensile strength), wherein the rubber composition further comprises

rubber (component A);

silica (component B); and

organosilane having at least one hydroxy, cyclic and/or bridged alkoxy group (component C). In a particular embodiment the rubber composition is comprised in a tire.

The invention is further illustrated with the following examples, without being limited thereto or thereby.

### EXAMPLES

### Preparation of Rubber Compositions

Rubber compositions were prepared with the formulations as detailed in Table 1.

The rubber compositions prepared differed in the type of organosilane used and if rosin-containing material was used (component D) in table 1 or not:

TABLE 1

| | Comp. | | | |
|---|---|---|---|---|
| Component (PHR) | Ex.1 | Ex.2 | Ex.3 | Ex.4 |
| (A) Rubber | 100.0 | 100.0 | 100.0 | 100.0 |
| (B) Silica | 80.0 | 80.0 | 80.0 | 80.0 |
| (C) Organosilane | 5.3 | 5.3 | 5.3 | 5.3 |
| (D) Rosin-containing | 0 | 1.0 | 0.0 | 1.0 |
| material | | | | |
| Additional components (PHR) | | | | |
| Mineral Oil | 31.3 | 31.3 | 31.3 | 31.3 |
| Vulcanization package | 10.7 | 10.7 | 10.7 | 10.7 |
| Carbon black | 10.0 | 10.0 | 10.0 | 10.0 |
| Antioxidants | 2 | 2 | 2 | 2 |
| Wax | 1.5 | 1.5 | 1.5 | 1.5 |

The rubber used consisted of a mixture of rubbers comprising 70 parts of Solution Styrene Butadiene Rubber (S-SBR) (Buna VSL VP PBR4041™, obtained from Lanxess), 30 parts of Butadiene Rubber (BR) (Buna CB24™, obtained from Lanxess).

The silica was precipitated silica (Ultrasil™ 7000 GR, obtained from Evonik).

In Examples 2 and 4, the rosin-containing material was a Tall Oil Rosin having a softening point 63° C. and an acid number of 168 mg KOH/g.

In Examples 1 and 2 the organosilane was the Mercaptothiocarboxylate Oligomer NXT Z45 purchased from Momentive.

In Examples 3 and 4 the organosilane was the Mercaptothiocarboxylate Oligomer NXT, purchased from Momentive.

The carbon black (CB) was Corax™ N330, purchased from Orion Engineered Carbons.

The mineral oil Treated Distillate Aromatic Extract (TDAE, Vivatec™ 500 purchased from Hansen & Rosenthal).

The antioxidants used was 2 phr of N-(1,3 dimethylbutyl)-N′ phenyl-p-phenylenediamine (6PPD, Vulkanox™ 4020 purchased from Lanxess

The wax was Antilux™ 654, purchased from Rheinchemie, Germany.

The vulcanization package consisted of 2.5 phr of zinc oxide (Zinc Oxide Red Seal™ purchased from Grillo), 2 phr of stearic acid, 2 phr of N-cyclohexyl-2-benzothiazole sulfenamide (CBS, Rhenogran® CBS-80 purchased from RheinChemie, Germany), 2 phr of diphenylguanidine (SDPG, Rhenogran® DPG-80, purchased from RheinChemie, Germany) and 2.2 phr of sulphur (Rhenogran® IS 60-75, purchased from RheinChemie, Germany).

Rubber compositions with different amounts of Rosin as indicated in Table 1 were prepared by mixing in a lab-scale Brabender type internal mixer (Haake Rheomix OS & Polylab OS from Thermo Scientific Mixer) using a four step mixing protocol.

In the first step the rubbers SBR and BR were introduced to the mixer and heated at 70° C. and 80 rpm. After 0.5 minutes, 50.5 phr of silica, 6.7 phr of the organosilane were added to the rubber.

The mixture was mixed at 80 RPM for 1 minute and further 50.5 phr of silica, the Rosin-containing material (1.3 phr) 3.7-4.6 phr of the mineral oil (TDAE), antioxidant (Vulkanox 4020 2.5 phr) and wax 0.9 phr (Antilux 654), Zinc Oxide 3.2 phr and 2.5 phr stearic acid were added to the mixture.

The mixture was mixed at 80 RPM for 1 minute and 12.6 phr Carbon Black and 6.3 phr of mineral oil (TDAE) were added to the mixture.

The mixture was mixed for a further 1.5 minutes to allow the mixture to reach a temperature of 150° C. The ram was then raised to allow for cleaning and then lowered. When the temperature reached 160° C. the mixture was dumped out of the mixer and allowed to cool at room temperature, to provide a first non-productive rubber mixture (STAGE 1 rubber).

In the second step, the STAGE 1 rubber was brought back into the mixer and was set to 80 RPM. After 2 minutes the ram was raised and lowered. When the temperature of 160° C. was reached, the mixture was dumped out of the mixer and allowed to cool at room temperature, to provide a second non-productive rubber mixture (STAGE 2 rubber).

In the third step, the STAGE 2 rubber was brought back into the mixer and the rotor was set to 50 RPM. The vulcanization package 6.2 phr (Rhenogran CBS-80 2 phr, Rhenogran DPG-80 2 phr, Rhenogran IS 60-75 2.2 phr) was added to the mixture. When the temperature of 105° C. was reached, the mixture was dumped out of the mixer and allowed to cool at room temperature, to provide a final productive mixture (FINAL STAGE).

The final productive mixtures were cured at 160° C. for 15 minutes and then used for physical dynamic and tensile mechanical tests.

### Performance of Rubber Compositions

As explained in more detail below, rubber compositions of examples 1-4, at different stages of production, were tested for different properties including Mooney viscosity, Tensile mechanical properties, Hardness and Rebound properties.

### Mooney Viscosity

The large rotor Mooney viscosity of the rubber compositions of examples 1-10 was determined at STAGE 1 according to procedures described in ASTM-D 1646-8911 (ISO 289). The test was performed using a large rotor at 100° C. The sample was preheated at the test temperature for 1 min before the rotor started and then the Mooney viscosity (ML(1+4) at 100° C.) was recorded as the torque after the rotor had rotated for 4 min at 2 rpm (average shear rate about 1.6 s⁻¹). The results are shown in Table 2a under ML(1+4) at 100° C.

TABLE 2A

| | | | |
|---|---|---|---|
| Example 1 | Example 2 | Example 3 | Example 4 |

ML (1 + 4) at 100° C. (in Mooney units)

| | | | | |
|---|---|---|---|---|
| STAGE 1 | 181.37 | 157.86 | 135.40 | 107.76 |
| rubber | | | | |

As it can be seen in Table 2a the Mooney viscosity (ML(1+4) at 100° C.) of the uncured rubber mixtures comprising rosin (STAGE 1 rubber of examples 2 and 4) are greatly diminished when compared to uncured mixtures of rubber compositions which do not comprise rosin (examples 1 and 3).

The reduction of the viscosity at 100° C. means that the production of products derived from rubber compositions comprising both rosin acid and an organosilane can be significantly improved.

In particular, the lower ML(1+4) at 100° C. in the non-productive stocks (STAGE 1) will facilitate the better rubber processing including ease for handling and the continuation of the mixing process which will greatly increase the plant productivity and the production throughput.

The viscosity of the final productive rubber mixtures was characterized by measuring torque before its build up during the curing process (ML 160° C.). This was conducted by recording the minimum torque using a Prescott Rheo-Line Moving Die Rheometer for monitoring the curing process according to the ISO 6502 or ASTM D5289 procedure. The testing conditions used were a frequency of 1.67 Hz and a strain of 7% at 160° C. The minimum torque recorded is shown in Table 2b under ML 160° C.

Table 2b sets forth the cure rate properties as determined using a moving die rheometer at 160° C. for 17 minutes of Examples 1-4 for the FINAL STAGE.

TABLE 2B

| | | | |
|---|---|---|---|
| Example 1 | Example 2 | Example 3 | Example 4 |

MDR @160° C.

| | | | | |
|---|---|---|---|---|
| M_{L} (dNm) | 2.84 | 2.61 | 2.71 | 2.76 |
| M_{H} (dNm) | 17.68 | 17.40 | 17.20 | 17.99 |
| M_{H}-M_{L} (dNm) | 14.84 | 14.79 | 14.49 | 15.23 |
| TC90% (min.) | 10.10 | 9.71 | 8.12 | 7.99 |

Table 3 sets forth the tensile mechanical properties of the Examples 1-4 after the FINAL STAGE. The tensile mechanical properties of the rubber can be measured using standard procedures such as those described in ASTM 6746-10 for uncured rubber and ISO 37 for cured rubber. Parameters commonly used in the art which may be measured include the tensile strengths measured at 50% elongation (M50), at 200% elongation (M200) and at 300% elongation (M300); the tensile strength at break (TB); and the elongation at break (EB). The M300/M100 ratio gives an idea of the reinforcement properties of the rubber composition.

TABLE 3

| | | | |
|---|---|---|---|
| Example 1 | Example 2 | Example 3 | Example 4 |

Tensile

| | | | | |
|---|---|---|---|---|
| M50 (MPa) | 1.25 | 1.27 | 1.30 | 1.43 |
| M100 (MPa) | 2.02 | 2.03 | 2.26 | 2.45 |
| M200 (MPa) | 4.97 | 4.91 | 6.25 | 6.42 |
| M300 (MPa) | 9.61 | 9.28 | 12.64 | 12.18 |
| M300/M100 | 4.75 | 4.57 | 5.61 | 4.96 |
| EB (%) | 421.44 | 482.41 | 403.27 | 399.89 |
| Tb (MPa) | 15.83 | 17.97 | 19.73 | 18.28 |

Table 4 sets forth the hardness and the rebound resilience after the FINAL STAGE of Examples 1-4. The hardness was measured using the Shore A scale at 22° C. according to ISO 7619-1 using a Wallace Shore A tester. Rebound Resilience was measured according to ISO 4662 at 22° C. and 60° C. using a Zwick/Roell rebound tester.

TABLE 4

| | | | |
|---|---|---|---|
| Example 1 | Example 2 | Example 3 | Example 4 |

Rebound Resilience

| | | | | |
|---|---|---|---|---|
| 23° C. (%) | 36.26 | 35.37 | 36.85 | 35.40 |
| 60° C. (%) | 55.26 | 55.13 | 58.15 | 54.29 |

Hardness

| | | | | |
|---|---|---|---|---|
| Shore A | 64.8 | 64 | 62.5 | 63.8 |

Table 2b, 3 and 4 indicates that the rosin containing compounds do not negatively impact the physical properties of the cured compound whilst improving the viscosity and therefore the processing of the compound.

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

It may be evident to those of ordinary skill in the art upon review of the exemplary embodiments herein that further modifications, equivalents, and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R=R_{L}+k(R_{U}−R_{L}), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims. All publications cited herein are incorporated by reference in their entirety.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including”to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

The preceding example and figures are meant only as illustrations; the following claims define the inventive subject matter.

1. A rubber composition comprising
(A) a rubber;
(B) silica;
(C) an organosilane having at least one hydroxy, cyclic and/or bridged alkoxy group; and
(D) a rosin-containing material comprising at least one rosin compound and derivatives thereof selected from at least one of rosin, dimerized rosin, hydrogenated rosin, disproportionated rosin, decarboxylated rosin and rosin ester.

2. The composition of claim 1, wherein the rosin containing-material has an acid number 0.5 to 190 mg KOH/g, in particular from 1 to 185 mg KOH/g, more in particular from 1.5 to 180 mg KOH/g, yet more in particular from 2 to 175 KOH/g; and/or has a softening point from 40 to 170° C., in particular from 45 to 160° C., more in particular from 50 to 150° C., yet more in particular from 55 to 145° C.

3. The rubber composition of claim 1, wherein the rosin-containing material is a rosin or derivative thereof, in particular selected from tall oil rosin, gum rosin, and wood rosin, and more in particular the rosin-containing material is tall oil rosin.

4. The rubber composition of any one of claim 1, wherein the organosilane has at least one mercapto and silanol functional groups.

5. The rubber composition of any one of claim 1, wherein the organosilane has both blocked and unblocked mercapto groups.

6. The rubber composition of any one of claim 1, wherein the cyclic and bridged alkoxy groups are derived from diols.

7. The rubber composition of any one of claim 1, wherein the blocking group comprises a carbonyl group.

8. The rubber composition of claim 7, wherein the blocking group is of formula —COR′, wherein
R′ is an unsubstituted or substituted branched or linear monovalent alkyl, alkenyl, aryl or aralkyl group having at least 1 carbon atoms, in particular at least 3 carbon atoms and more in particular at least 5 carbon atoms, and more in particular at least 7 atoms.

9. The rubber composition of any one of claim 7, wherein the blocking group is an octanoyl group.

10. The rubber composition of any one of claim 1, wherein the organosilane is an organosilane of formula (I): 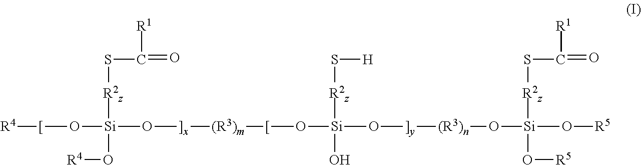
wherein R¹ is a hydrocarbon radical containing from 4 to 10 carbons, preferably an alkyl radical and preferably containing 7 carbon atoms;
wherein R² is an alkylene radical containing from 3 to 6 carbon atoms, preferably 4 carbon atoms;
wherein R³ is an alkylene radical containing from 3 to 8 carbon carbon atoms, preferably 4 carbon atoms;
wherein the R⁴ radicals are the same or different alkyl radicals containing from 3 to 8 carbon atoms;
wherein the R⁵ radicals are:
(A) The same or different alkyl radicals containing from 3 to 8 carbon atoms, or
(B) Combined to form an individual alkyl radical, which may be a branched or unbranched alkyl radical, having from 3 to 8 carbon atoms;
wherein z is a value in the range of from 3 to 6;
wherein the total of x and y is at least 3, which may be, for example of from 0 to about 15 or more; and
wherein m and n are each values in a range of from 0 to 8.

11. The rubber composition of claim 10, wherein
wherein z is a value in the range of from 3 to 6;
wherein the total of x and y is at least 3, which may be, for example of from 3 to about 15 or more; and
wherein m and n are each values in a range of from 3 to 8.

12. The rubber composition of any one of claim 1, wherein the organosilane is a monomer, dimer or oligomer.

13. The rubber composition of any one of claim 1, wherein the organosilane is an oligomer.

14. The rubber composition of any one of claim 1, wherein the rubber (A) is selected from at least one of styrene/butadiene copolymer (SBR), polybutadiene (BR), natural rubber, polyisoprene, isoprene isobutylene copolymer (IIR), styrene/isoprene/butadiene terpolymer (SIBR), and isoprene/styrene copolymer.

15. The rubber composition of any one of claim 1, wherein the amount of the organosilane (C) is from 0.05 to 75 phr, in particular from 0.1 to 60 phr, more in particular from 0.5 to 50 phr, more in particular from 1 to 30 phr, even more in particular from 5 to 15 phr wherein phr is the weight parts of organosilane per 100 weight parts of rubber component (A).

16. The rubber composition of any one of claim 1, wherein the amount of rosin-containing material (D) is from 0.001 to 75 phr, in particular from 0.01 to 50 phr, in particular from 0.1 to 25 phr, more in particular from 0.25 to 10 phr, even more in particular from 0.5 to 5.0 phr wherein phr is the weight parts of rosin-containing material per 100 weight parts of rubber component (A).

17. The rubber composition of any one of the claim 1, wherein the amount of silica (B) is from 5 to 150 phr, in particular from 25 to 130 phr, in particular from 40 to 115, wherein phr is the weight parts of silica per 100 weight parts of rubber component (A).

18. The rubber composition of any one of claim 1, comprising 5-150 phr of silica (B), 0.05-75 phr of the organosilane (C) and 0.001-75 phr of the rosin-containing material (D), wherein phr is the weight parts of each component (B), (C) or (D) per 100 weight parts of rubber component (A).

19. The rubber composition of any one of claim 1, having, when the rubber composition is in STAGE 1, a Mooney viscosity from 1 to 75% lower, in particular from 2 to 60% lower, more in particular from 3 to 50% lower, even more in particular from 4 to 40% lower than the Mooney viscosity of a similar rubber composition without a rosin-containing material.

20. A tire comprising the rubber composition of any one of claim 1.

21. Use of a rosin-containing material selected from rosin, dimerized rosin, hydrogenated rosin, disproportionated rosin, decarboxylated rosin and rosin ester (component D)
in a rubber composition further comprising
a rubber (component A);
silica (component B); and
an organosilane having at least one hydroxy, cyclic and/or bridged alkoxy group;
to obtain a rubber composition having, when the rubber composition is not cured, a reduced Mooney viscosity when compared to a similar uncured rubber composition without component D.

22. A method for preparing a rubber composition according to any one of the claim 1, comprising mixing:
(A) a rubber;
(B) silica;
(C) an organosilane having at least one hydroxy, cyclic and/or bridged alkoxy group; and
(D) a rosin-containing material selected from rosin, dimerized rosin, hydrogenated rosin, disproportionated rosin, decarboxylated rosin and rosin ester.
